(19) United States
(12) Patent Application Publication
(10) Pub. No.: US 2010/0235427 A1
(43) Pub. Date: Sep. 16, 2010

(54) CONTENT DELIVERY SYSTEM, SERVER DEVICE, CONTENT DELIVERY METHOD, AND PROGRAM

(75) Inventors: Toshihiro Sotomaru, Saitama (JP); Kinya Ono, Saitama (JP); Kunihiro Minoshima, Saitama (JP)

Correspondence Address: FOLEY AND LARDNER LLP;SUITE 500, 3000 K STREET NW, WASHINGTON, DC, 20007, US

(73) Assignee: PIONEER CORPORATION, Tokyo (JP)

(21) Appl. No.: 12/294,493

(22) PCT Filed: Mar. 26, 2007
(86) PCT No.: PCT/JP2007/056254

§ 371 Date: Nov. 25, 2008

(30) Foreign Application Priority Data
Mar. 28, 2006 (JP) 2006-089060

(51) Int. Cl. G06F 15/16

(52) U.S. Cl. 709/203

(57) ABSTRACT

A system of the invention is configured to communicably connect a server device that holds content data and a client apparatus that requests to reproduce the content data. The server device transmits a list of the reproducing identifier to the client apparatus, receives the reproducing identifier included in the list from the client apparatus, and acquires the content identifier and the reproducing mode information stored in the content information storage unit corresponding to the reproducing identifier received by the request receiving unit. The server device acquires the content data stored in the content storage unit corresponding to the content identifier, and transmits the content data to the client apparatus in the reproducing mode designated by the reproducing mode information.

### TECHNICAL FIELD

The present invention relates to a content delivery system, a server device, a content delivery method, and a program.

### BACKGROUND ART

In a conventional network/client server system that performs a partial reproducing process of contents, information such as position information related to partial reproducing of contents are shared by a client apparatus and a server device, and the client apparatus issues a partial reproducing request to the server device to realize partial reproducing of the contents (see Patent Document 1). More specifically, in Patent Document 1, both the client apparatus and the server device implement units that share partial reproducing information of contents, an interpreting method, and transmission/reception and an interpreting method of a content partial reproducing command to realize partial reproducing of the contents.

Patent Document 1: Japanese Patent Application Laid-open No. 2004-295568

### DISCLOSURE OF INVENTION

### Problem to be Solved by the Invention

However, in a conventional art, there is a problem that it is impossible to realize partial reproducing of contents unless both the client apparatus and the server device implement the units that share information such as position information related to partial reproducing, the interpreting method, and the transmission/reception and the interpreting method of the content partial reproducing command. Problems to be solved by the invention include the above problem, for example.

The present invention has been made in consideration of the above problem, and its object is to provide a content delivery system, a server device, a content delivery method, and a program in which information related to chapter reproducing is held by only the server device, and partial reproducing of contents can be easily performed without using sharing of reproducing start position information by the client apparatus and the server device, and control using a reproducing start position or the like as an argument, or the like.

### Means for Solving Problem

A content delivery system according to one aspect of the present invention is configured to communicably connect a server device that holds content data and a client apparatus that requests to reproduce the content data, wherein the server device includes a storage device and a control device, the storage device includes a content storage unit that stores a content identifier which uniquely identifies the content data and the content data in association with each other, and a content information storage unit that stores a reproducing identifier which manages the content identifier and reproducing mode information which defines a reproducing mode of the content data specified by the content identifier in association with each other, and the control device includes a list transmitting unit that transmits a list of the reproducing identifier to the client apparatus, a request receiving unit that receives the reproducing identifier included in the list from the client apparatus, and a content transmitting unit that acquires the content identifier and the reproducing mode information stored in the content information storage unit corresponding to the reproducing identifier received by the request receiving unit, acquires the content data stored in the content storage unit corresponding to the content identifier, and transmits the content data to the client apparatus in the reproducing mode designated by the reproducing mode information.

A server device according to another aspect of the present invention in a content delivery system that is configured to communicably connect the server device that holds content data and a client apparatus that requests to reproduce the content data, includes a storage device, and a control device, wherein the storage device includes a content storage unit that stores a content identifier which uniquely identifies the content data and the content data in association with each other, and a content information storage unit that stores a reproducing identifier which manages the content identifier and reproducing mode information which defines a reproducing mode of the content data specified by the content identifier in association with each other, and the control device includes a list transmitting unit that transmits a list of the reproducing identifier to the client apparatus, a request receiving unit that receives the reproducing identifier included in the list from the client apparatus, and a content transmitting unit that acquires the content identifier and the reproducing mode information stored in the content information storage unit corresponding to the reproducing identifier received by the request receiving unit, acquires the content data stored in the content storage unit corresponding to the content identifier, and transmits the content data to the client apparatus in the reproducing mode designated by the reproducing mode information.

A content delivery method according to still another aspect of the present invention is executed by a content delivery system that is configured to communicably connect a server device that holds content data and a client apparatus that requests to reproduce the content data, wherein the server device includes a storage device and a control device, the storage device includes a content storage unit that stores a content identifier which uniquely identifies the content data and the content data in association with each other, and a content information storage unit that stores a reproducing identifier which manages the content identifier and reproducing mode information which defines a reproducing mode of the content data specified by the content identifier in association with each other, and the method includes a list transmitting step of transmitting a list of the reproducing identifier to the client apparatus, a request receiving step of receiving the reproducing identifier included in the list from the client apparatus, and a content transmitting step of acquiring the content identifier and the reproducing mode information stored in the content information storage unit corresponding to the reproducing identifier received by the request receiving unit, acquires the content data stored in the content storage unit corresponding to the content identifier, and transmits the content data to the client apparatus in the reproducing mode designated by the reproducing mode information.

A computer program according to still another aspect of the present invention is executed by a server device in a content delivery system that is configured to communicably connect the server device that holds content data and a client apparatus that requests to reproduce the content data, including a storage device, and a control device, and the computer program includes a content storage unit that stores a content identifier which uniquely identifies the content data and the content data in association with each other, a content information storage unit that stores a reproducing identifier which manages the content identifier and reproducing mode information which defines a reproducing mode of the content data specified by the content identifier in association with each other, a list transmitting unit that transmits a list of the reproducing identifier to the client apparatus, a request receiving unit that receives the reproducing identifier included in the list from the client apparatus, and a content transmitting unit that acquires the content identifier and the reproducing mode information stored in the content information storage unit corresponding to the reproducing identifier received by the request receiving unit, acquires the content data stored in the content storage unit corresponding to the content identifier, and transmits the content data to the client apparatus in the reproducing mode designated by the reproducing mode information.

### BRIEF DESCRIPTION OF DRAWINGS

FIG. 1 is a block diagram showing an example of a configuration of a server device 100 to which the present embodiment is applied.

FIG. 2 is a block diagram showing an example of a software configuration of the server device 100 to which the present embodiment is applied.

FIG. 3 is a block diagram showing an example of a configuration of a client apparatus 300 to which the present embodiment is applied.

FIG. 4 is a block diagram showing an example of a software configuration of the client apparatus 300 to which the present embodiment is applied.

FIG. 5 is a diagram for showing an example of chapter reproducing management information in a content information database (DB) 205.

FIG. 6 is a conceptual diagram showing an example of a content list management tree of the contents managed by the server device 100.

FIG. 7 is a sequence diagram for showing an example of a chapter reproducing sequence in the server device 100 and the client apparatus 300.

FIG. 8 is a diagram showing an example of chapter display in the client apparatus 300.

FIG. 9 is a conceptual diagram for showing a display of a middle part reproducing list on the client apparatus 300 side.

FIG. 10 is a flow chart for showing an example of a forming process of chapter reproducing management information on the server side executed by a content managing unit 204 of the server device 100 or the like.

FIG. 11 is a flow chart for showing an example of an adding process of the chapter reproducing management information on the server side executed by the content managing unit 204 of the server device 100 or the like.

FIG. 12 is a flow chart for showing an example of a chapter reproducing process on the server side executed by the server device 100.

FIG. 13 is a sequence diagram for showing an example of a generating process of middle part reproducing management information on the server device 100 and the client apparatus 300.

FIG. 14 is a flow chart for showing an example of a generating process of the middle part reproducing management information on the server device 100.

FIG. 15 is a diagram for showing outline of digest reproducing management information and a reproducing section list.

FIG. 16 is a view for showing outline of continuous reproducing management information.

FIG. 17 is a flow chart for showing an example of a continuous reproducing process executed by the server device 100.

FIG. 18 is a diagram for showing outline of chorus continuous reproducing management information.

FIG. 19 is a diagram for showing an outline of continuous reproducing management information.

FIG. 20 is a diagram for showing an outline of repeat reproducing management information.

FIG. 21 is a flow chart for showing an example of a repeat reproducing process executed in the server device 100.

FIG. 22 is a diagram for showing an example of response data on the server side corresponding to a request from the client apparatus 300 using HTML.

FIG. 23 is a flow chart for showing an example of a middle part reproducing process of a plurality of rate contents executed by the server device 100.

FIG. 24 is a diagram for showing an outline of content base identifier management information.

FIG. 25 is a diagram for showing an example of response data on the server side corresponding to a request of a content directory service (CDS) browsing or the like from the client apparatus 300 that uses an universal plug and play (UPnP) CDS.

### EXPLANATIONS OF LETTERS OR NUMERALS

100 server device
101 central processing unit (CPU)
102 read-only memory (ROM)
103 random access memory (RAM)
104 storage device
105 communication interface
201 content storage unit
202 communication processing unit
203 content delivering process unit
204 content managing unit
205 content information DB
300 client apparatus
301 CPU
302 ROM
303 RAM
304 communication interface
305 display
306 user interface
401 communication processing unit
402 display processing unit
403 user inputting process unit
404 content receiving process unit
405 control information processing unit

### BEST MODE(S) FOR CARRYING OUT THE INVENTION

The following describes an embodiment of a content delivery system, a server device, and a content delivery method according to the present invention in detail with reference to the drawings. The embodiment is illustrative only, and is not intended to limit the present invention in any way.

[Overview of the System]

The following outlines the present invention, and then, a configuration and processing of the present system are explained in detail.

In general, the system is configured to communicably connect the server device that holds content data and the client apparatus that requests to reproduce partially a chapter of the content data or the like.

In general, the system has schematically following basic features. That is to say, the server device has a storage device and a control device.

The storage device stores a content identifier which uniquely identifies the content data and the content data in association with each other, and a reproducing identifier (for example, uniform resource identifier (URI)) which manages the content identifier and reproducing mode information which defines a reproducing mode of the content data specified by the content identifier in association with each other.

The reproducing mode information may have at least one of reproducing start position information, reproducing range information, and reproducing control information (for example, the number of times of reproducing, repeat, an encoding rate, and a format). The plurality of pieces of reproducing mode information may correspond to the one reproducing identifier, and the plurality of content identifiers and the plurality of pieces of reproducing mode information may correspond to the one reproducing identifier.

The control device transmits a list of the reproducing identifier to the client apparatus, and receives the reproducing identifier included in the list from the client apparatus. The control device acquires the content identifier and the reproducing mode information corresponding to the reproducing identifier received, acquires the content data corresponding to the content identifier according to the reproducing mode information, and transmits the data to the client apparatus.

In this case, a method of presenting the list of the reproducing identifiers (for example, a URI for chapter reproducing) generated and held by the server device to the client apparatus can be realized by any method. The client apparatus makes a content acquiring request to the server device by using the reproducing identifier acquired from the server device by a method to realize partial reproducing of content data such as chapter reproducing.

The server device may generate a chapter reproducing URI list of a format according to, for example, UPnP CDS. In this case, the client apparatus acquires a chapter reproducing URI list according to a format of the CDS. A user who operates the client apparatus selects a chapter to be reproduced in the list. The client apparatus makes an acquiring request of the contents to the server device by using a chapter reproducing URI corresponding to the selected chapter.

The server device that has received the request acquires information corresponding to the received URI from the chapter reproducing URI list, specifies contents to be reproduced, specifies a reproducing mode such as a reproducing start position, and transmits the reproducing mode to the client apparatus to realize chapter reproducing.

In this manner, according to the system according to the embodiment, information related to partial reproducing of content data such as a chapter is held by only the server device, and partial reproducing or the like can be realized without using sharing of information such as a reproducing start position by both the client apparatus and the server device, and control using the reproducing start position or the like as an argument, or the like.

A reproducing identifier such as a chapter reproducing URI used in the embodiment has a general format, and the client apparatus needs not perform special interpretation or generation of a URI to a chapter reproducing URI acquired by the client apparatus through a CDS of the server device. Therefore, the client apparatus may only have a basic CDS use function and a content requesting function by a URI. For this reason, the client apparatus, may only have a content requesting function using a general URI, which is typified by a chapter reproducing URI acquiring method, a Web client apparatus, or the like.

In this manner, when information of a reproducing identifier published by the server device is set as a URI format, the client apparatus can perform content streaming reproducing in a method other than a general reproducing method even when a special command, data type interpretation, and generation of a control command cannot be performed.

When the server device of the system also generates information (user-friendly descriptive text or the like) attached to the URI in generation of the URI and makes the information presentable to the client apparatus, the client apparatus that has acquired a content list can present (display) the pieces of information (descriptive text) to a user who operates the client apparatus equipment.

Furthermore, the server device of the system dynamically generates a URI serving as a reproducing identifier to make it possible to generate a content viewing method generated by a user operation or the like and a URI corresponding to the method. Accordingly, after normal reproducing, even after the viewing of contents is stopped, the contents can be viewed from a middle part by using a middle part reproducing URI provided by the server device without causing the client apparatus to store a stop position. Since the server device stores a middle part position and is provided with the middle part reproducing URI, the contents can be viewed from a middle part even from a client apparatus different from the client apparatus that has stopped the viewing.

In generation of the middle part reproducing URI, the server device also generates information (user-friendly descriptive text or the like) attached to the URI and makes the information presentable to the client apparatus. In this case, the client apparatus that has acquired a content list can present (display) the pieces of information (descriptive text) to a user who operates the client apparatus equipment.

The server device may detect content information generation/updating, a reproducing stop, or the like and generate, triggered by the detection, contents data specified by a content identifier and a URI (reproducing identifier) associated with information in which a reproducing method of the contents is described. At the same time, the server device makes these URIs presentable to the client apparatus (CDS database updating or the like). The server device that has received a request to the URI from the client apparatus may specify contents by a content identifier associated with the URI and determines an output method of the contents according to the content reproducing method associated with the URI.

[Configuration of the System]

The following describes a configuration of the system for realizing the basic features.

[Configuration of the System: the Server Device 100]

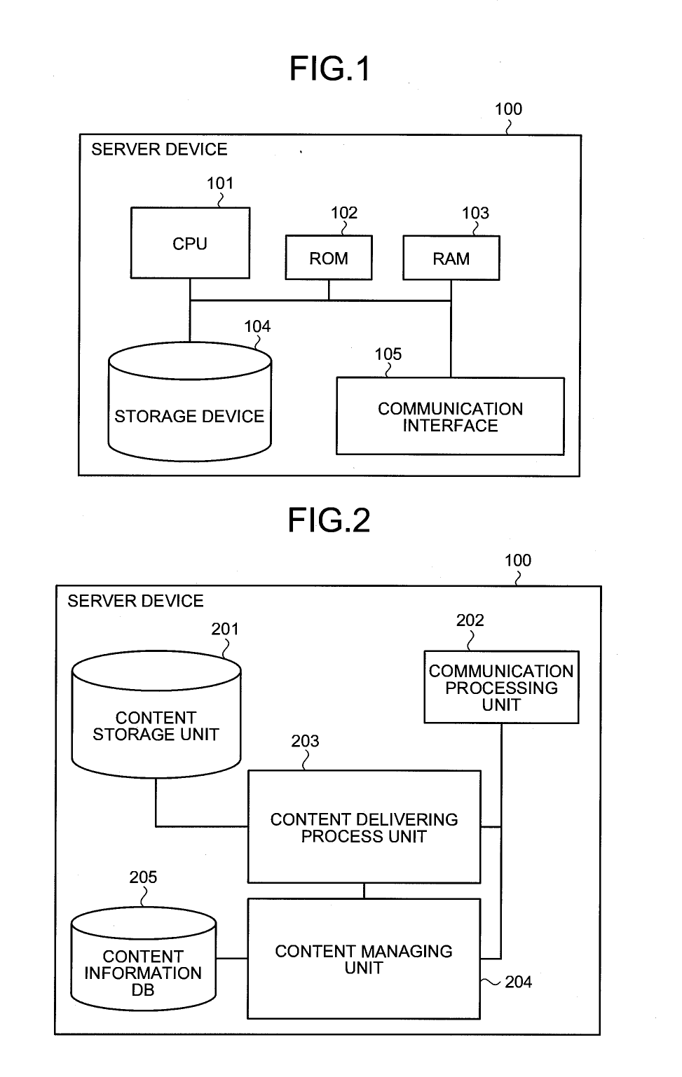

The following first describes a configuration of a server device 100 with reference to FIGS. 1 and 2.

FIG. 1 is a block diagram showing an example of a configuration of the server device 100 to which the present embodiment is applied, and conceptually shows only parts related to the present invention.

In FIG. 1, in general, the server device 100 is provided with a storage device 104 for storing contents, a communication interface 105 that communicates thorough a network, memory devices (ROM 102 and RAM 103), and a control device (CPU 101) that control these devices.

The storage device 104 (or memory device) act as a content storage unit that stores a content identifier which uniquely identifies the content data and the content data in association with each other, a content information storage unit that stores a reproducing identifier which manages the content identifier and reproducing mode information which defines a reproducing mode of the content data specified by the content identifier in association with each other, and the like.

The control device (CPU 101) act as a list transmitting unit that transmits a list of the reproducing identifier to the client apparatus, a request receiving unit that receives the reproducing identifier selected by a user in the reproducing identifiers included in the list from the client apparatus, a content transmitting unit that acquires the content identifier and a reproducing start position stored in the content information storage unit corresponding to the reproducing identifier received by the request receiving unit, acquires the content data from the reproducing start position stored in the content storage unit corresponding to the content identifier, and transmits the content data to the client apparatus, and the like.

FIG. 2 is a block diagram showing an example of a software configuration of the server device 100 to which the present embodiment is applied, and conceptually shows only parts related to the present invention.

In FIG. 2, the software configuration of the server device 100 is provided with a content storage unit 201 that is a content storage unit that stores a content identifier which uniquely identifies the content data and the content data in association with each other, a content information DB 205 that holds various content management information stored in the server device 100 (for example, chapter reproducing management information, digest reproducing management information, continuous reproducing management information, chorus continuous reproducing management information, repeat reproducing management information, and a content base identifier management table as described later), a content delivering process unit 203 that controls delivering content data, a content managing unit 204 that executes update/provision processing of various content management information, and a communication processing unit 202 executing communication processing with external devices. All the functions can be executed by CPU 101, ROM 102, RAM 103, the storage device 104, and the communication interface 105 in the hardware configuration of the server device 100, and programs controlling these devices or the like.

[Configuration of the System: the Client Apparatus 300]

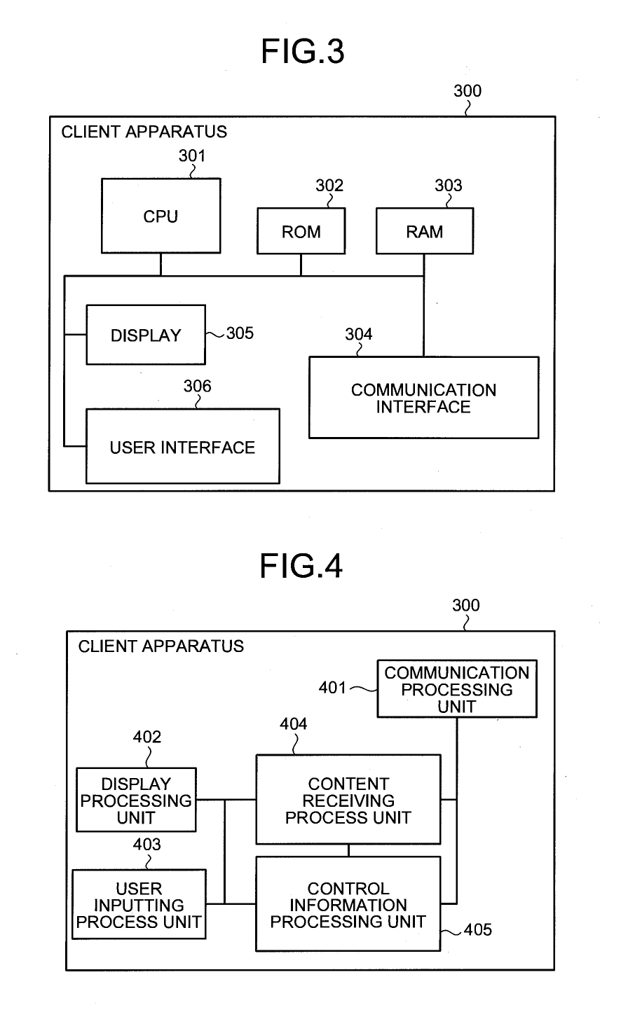

The following describes a configuration of a client apparatus 300 with reference to FIGS. 3 and 4. FIG. 3 is a block diagram showing an example of a configuration of the client apparatus 300 to which the present embodiment is applied, and conceptually shows only parts related to the present invention.

As shown in FIG. 3, in general, the client apparatus 300 is provided with a communication interface 304 that communicates thorough a network, a user interface 306, a display 305 that displays contents and a graphical user interface, memory devices (ROM 302 and RAM 303), and a control device (CPU 301) that controls these devices.

FIG. 4 is a block diagram showing an example of a software configuration of the client apparatus 300 to which the present embodiment is applied, and conceptually shows only parts related to the present invention.

In FIG. 4, the software configuration of the client apparatus 300 is provided with a communication processing unit 401 communicating with the server device 100, a content receiving process unit 404 that executes receiving process of content data, a control information processing unit 405 that executes management of content control information, and acquisition and management of a content list, a user inputting process unit 403 that receives input from a user, and a display processing unit 402 that displays contents and a graphical user interface. All the functions can be executed by CPU 301, ROM 302, RAM 303, the communication interface 304, and the display 305 in the hardware configuration of the client apparatus 300, and programs controlling these devices or the like.

[Overview of Processing of the System]

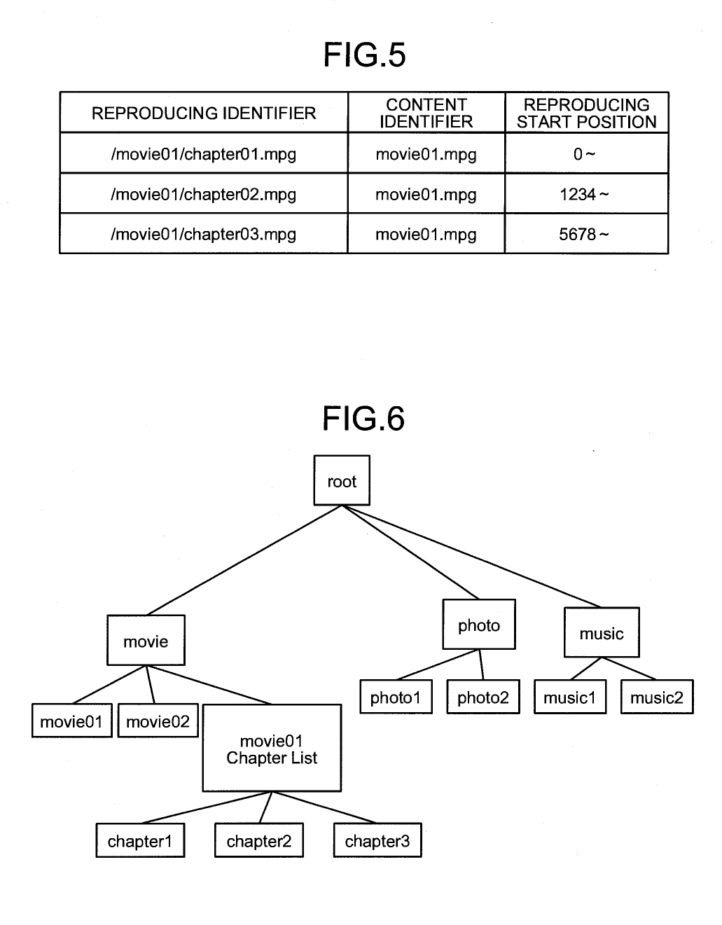

The following describes in detail an overview of processing of the system according to the present embodiment as configured above with reference to FIGS. 5 to 8, 10, 11, and 12.

In the server device 100, moving image contents are stored in advance (content storage unit 201). As reproducing mode information, information called a chapter representing a specific reproducing position of a moving image is stored as additional information of the moving image contents (content information DB 205). In general, when a chapter is designated to reproduce a moving image, reproducing can be performed from a predetermined position of the moving image contents. Chapter information which is one of pieces of reproducing mode information is generally expressed by the number of bytes counted from the start of the contents, the number of sectors, elapsed time of reproducing from the start of the contents, and the like.

The server device 100 adds an identifier to specify contents such as a file name for each of the moving image contents to make it possible to specify the moving image contents. For example, a URI is allocated to each of the moving image contents to make it possible to specify the moving image contents of the server device 100 from the client apparatus 300 connected through a network.

FIG. 5 is a diagram for showing an example of chapter reproducing management information in the content information DB 205. As shown in FIG. 5, one piece of chapter information or a plurality of pieces of chapter information are added to one of contents managed by the server device 100 as reproducing mode information. In this case, a URI (reproducing identifier) for chapter reproducing is newly allocated to each of the pieces of chapter information. For this reason, a content identifier and a reproducing start position of moving image contents specified by an identifier such as a file name is associated with a reproducing identifier serving as a newly allocated URI.

Although the URI includes an identifier representing a scheme host, the identifier (IP address or the like) representing the host may dynamically change. In this case, on a network, a process of the server device 100 after a host (server device 100) is specified may be handled.

For this reason, in the content information DB 205 of the server device 100, the server device 100 may hold only a character string representing “path” which does not overlap. In this case, on the assumption that an IP address does not dynamically change, the IP address may be buried. More specifically, for chapter reproducing management information shown in FIG. 5, a character string representing a “path” of a URI is used as a reproducing identifier to specify a chapter reproducing method.

In the embodiment, the character string representing the “path” has a format according to RFC3986. For this reason, the reproducing identifier used can be handled as the “path” in the URI.

Furthermore, the server device 100 is configured to make it possible to provide a content list of the server device 100 to the client apparatus 300 by UPnP CDS or the like to notify the client apparatus 300 of managed contents. The content list also includes a URI that specifies moving image contents.

Furthermore, a URI for chapter reproducing is also provided by the CDS to make it possible to specify moving image contents and a reproducing start position of the moving image contents.

FIG. 6 is a conceptual diagram showing an example of a content list management tree of the contents managed by the server device 100. A “path” portion of the chapter reproducing URI may include the reproducing identifier.

Container is set for each of the moving image contents, and the chapter reproducing URI may be described as Item in the Container.

Furthermore, a user-friendly descriptive text expressing what the chapter reproducing URI designates may be added as attached information. Thereby, the client apparatus 300 that has acquired a content list from the CDS can present (display) the descriptive text to a user.

In this case, as an example of the user-friendly descriptive text, for example, “xxx (movie title) chapter 2” or the like is given. Similarly, a descriptive text such as “xxx (movie title) chapter reproducing list” may also be added to each Container.

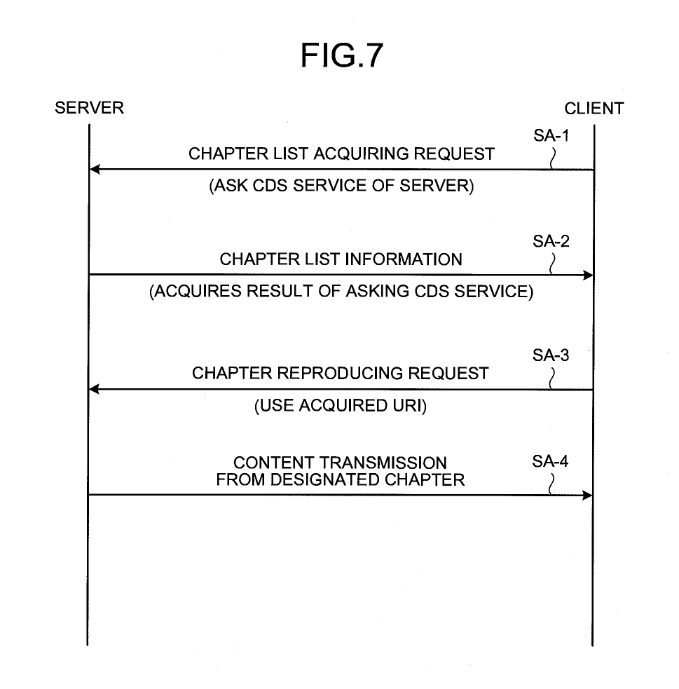

An example of an operation in which the client apparatus 300 reproduces movie01.mpg which is moving image contents shown in, for example, FIG. 6 from chapter 2 (“chapter 2” in FIG. 6) will be described below. FIG. 7 is a sequence diagram for showing an example of a chapter reproducing sequence in the server device 100 and the client apparatus 300.

The client apparatus 300 asks a CDS of the server device 100 to acquire chapter list information of movie01.mpg (step SA-1, step SA-2). The chapter list information includes a URI (reproducing identifier) that specifies each chapter shown in FIG. 5.

The user interface 306 of the client apparatus 300 displays a chapter list.

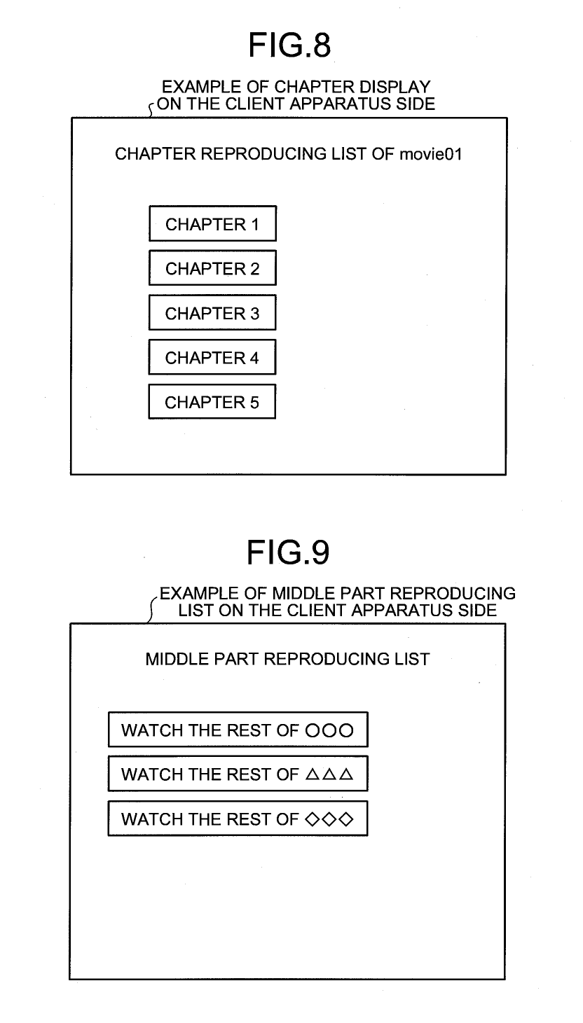

In this case, a user-friendly descriptive text attached to each URL may also be presented. FIG. 8 is a diagram showing an example of a chapter display in the client apparatus 300. For example, as shown in FIG. 8, “xxx (movie title indicating movie01.mpg) chapter 1”, “xxx chapter 2”, and the like are displayed on a screen. A user refers to the descriptive text to select, for example, chapter 2.

In this case, the client apparatus 300 designates, for example, a URI representing chapter 2 in FIG. 8 and makes a moving image content acquiring request to the server device 100 (step SA-3).

The server device 100 collates the URI designated from the client apparatus 300 and the chapter reproducing management information (FIG. 5), determines that the URI should be transmitted from a position 1234 of the moving image contents movie01.mpg to the client apparatus 300, acquires data subsequent to the position 1234 of movie01.mpg from the content storage device, and sequentially transmits the data to the client apparatus 300 (step SA-4).

The client apparatus 300 that has received the data can reproduce the contents from chapter 2.

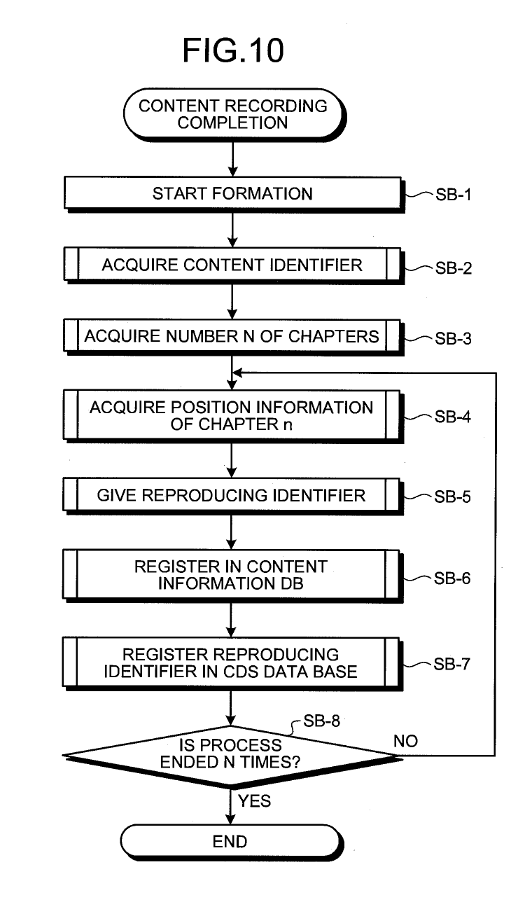

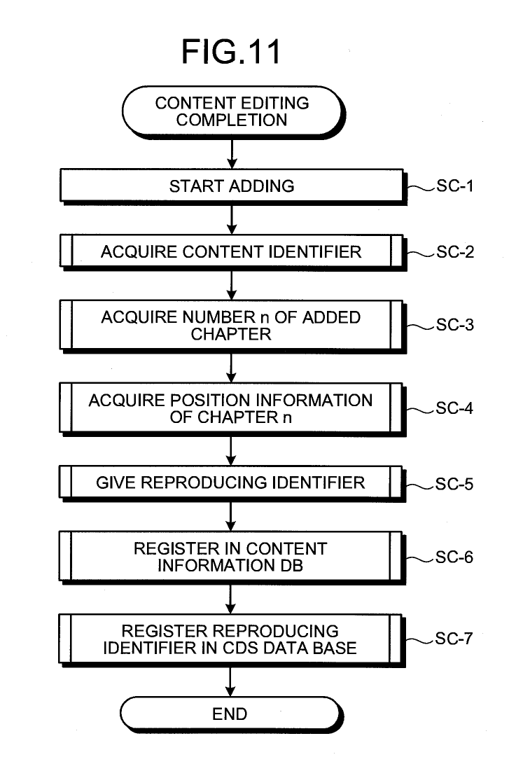

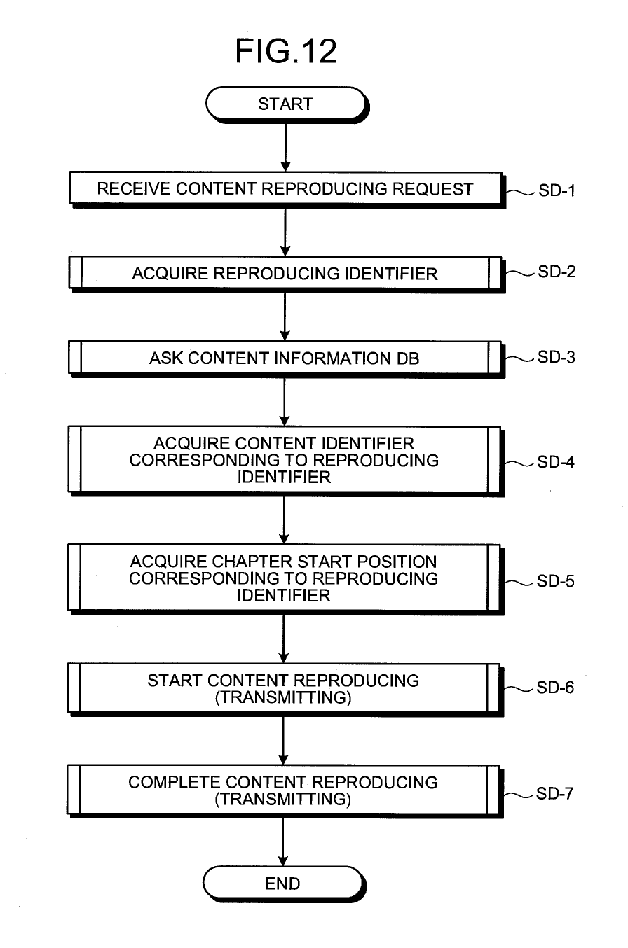

FIG. 10 is a flow chart for showing an example of a forming process of chapter reproducing management information on the server side executed by the content managing unit 204 of the server device 100 or the like, FIG. 11 is a flow chart for showing an example of a adding process of the chapter reproducing management information on the server side executed by the content managing unit 204 of the server device 100 or the like, and FIG. 12 is a flow chart for showing an example of a chapter reproducing process on the server side executed by the server device 100.

In this case, a forming process of chapter reproducing management information shown in FIG. 10 is started by using completion of recording of contents having chapter information as a trigger (step SB-1).

The content managing unit 204 acquires a content identifier serving as a hint to access content information (step SB-2).

The content managing unit 204 acquires, the number N of all chapters added to the contents (step SB-3).

The content managing unit 204 acquires position information of a chapter n (for example, information which specifies the start of a chapter such as sector information on a hard disk, and time information from the start of the contents) (step SB-4).

The content managing unit 204 gives a reproducing identifier which is a character string such as /movie/chapter01.mpg and which does not overlap another reproducing identifier of the server device 100 (step SB-5).

The content managing unit 204 registers the “content identifier”, the “chapter start information”, and the “reproducing identifier” described in FIG. 5 in the content information DB 205 (step SB-6).

The content managing unit 204 registers the reproducing identifier in a CDS database in the storage device 104 (step SB-7). The reproducing identifier has a URI format (for example, http://192.168.1.2:8080/movie/chapter01.mpg) when the reproducing identifier is output to the client apparatus 300.

The content managing unit 204 executes processes in the step SB-4 to step SB-7 to all chapters (step SB-8).

The forming process of the chapter reproducing management information on the server side is terminated.

The following describes an example of the adding process of the chapter reproducing management information on the server side with reference to FIG. 11.

In this case, the adding process of the chapter reproducing management information shown in FIG. 11 is started by editing certain recorded contents and adding a new chapter as a trigger (step SC-1). In FIG. 11, since processes in step SC-1 to step SC-7 executed by the content managing unit 204 are the same as the processes in the step SB-1 to the step SB-7 described in FIG. 10, an explanation thereof will be omitted.

The following describes an example of the chapter reproducing process on the server side with reference to FIG. 12.

The client apparatus 300 acquires an URI character string such as http://192.168.1.1:8080/movie/chapter01.mpg in advance by the CDS. The client apparatus 300 makes a content reproducing request by using the URI (step SD-1).

The content managing unit 204 acquires a reproducing identifier such as /movie/chapter01.mpg from the URI (step SD-2).

The content managing unit 204 asks the content information DB 205 to obtain a hint to access contents and content information (step SD-3).

The content managing unit 204 acquires a content identifier (see FIG. 5) corresponding to a reproducing identifier (step SD-4).

The content managing unit 204 acquires chapter start position information (for example, information which specifies the start of a chapter such as sector information on a hard disk, and time information from the start of the contents) which is reproducing mode information corresponding to the reproducing identifier (step SD-5).

The content delivering process unit 203 extracts contents data from the content storage unit 201 as needed on the basis of the information, transmits the content data to the client apparatus 300, and reproduces the content data (step SD-6).

The content delivering process unit 203 ends content reproducing (transmitting) (step SD-7).

The chapter reproducing process on the server side is terminated.

[Middle Part Reproducing Process]

The following describes details of a middle part reproducing process with reference to FIGS. 9, 13, and 14. In the above embodiment, the chapter reproducing URI related to the chapter reproducing information is generated in advance. This is dynamically generated to make it possible to realize middle part reproducing as will be described later.

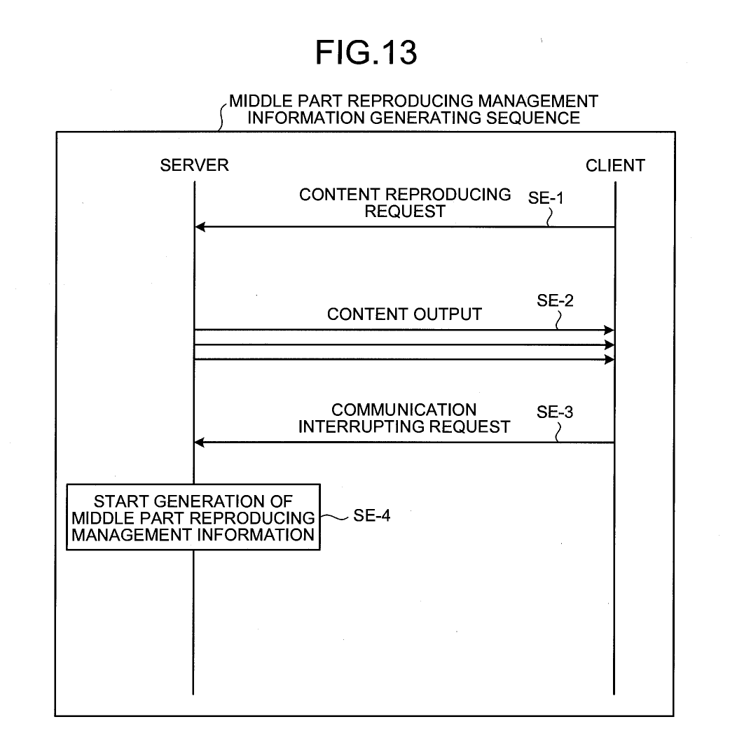

FIG. 13 is a sequence diagram for showing an example of a generating process of middle part reproducing management information on the server device 100 and the client apparatus 300.

It is assumed that the client apparatus 300 performs streaming reproducing while acquiring contents from the server device 100 (step SE-1 and step SE-2), and that a user who operates the client apparatus 300 stops viewing (step SE-3).

At this time, the server device 100 starts a generating process of middle part reproducing management information (step SE-4).

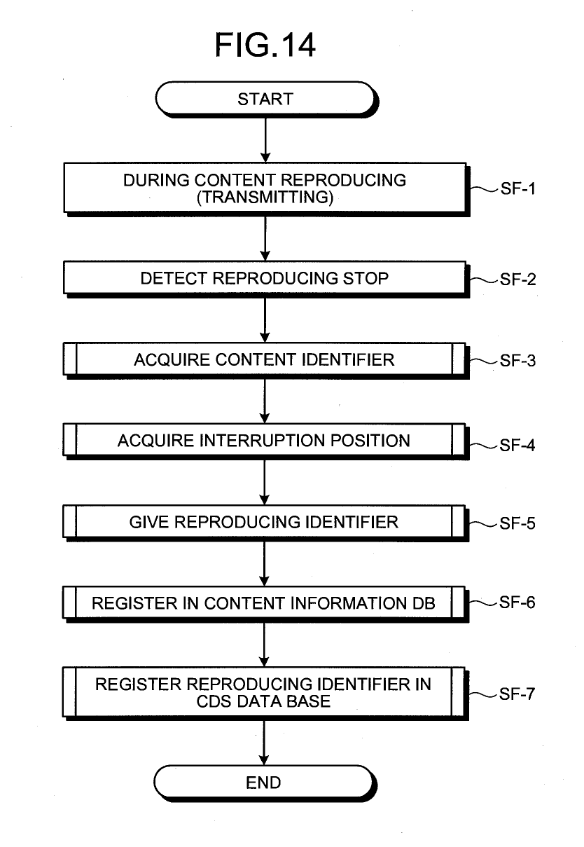

FIG. 14 is a flow chart for showing an example of a generating process of the middle part reproducing management information on the server device 100.

When the content delivering process unit 203 transmits contents in response to a request from the client apparatus 300 (step SF-1), the content delivering process unit 203 starts the generating process of the middle part reproducing management information by using interruption of TCP communication from the client apparatus 300 or reception of a stopping operation from the client apparatus 300 as a trigger (step SF-2).

The content managing unit 204 acquires a content identifier which is being transmitted currently (step SF-3) and holds position information transmitted to the client apparatus 300 of the contents (for example, a sector of the contents on a hard disk, and reproducing elapsed time from the start of the contents) (step SF-4).

The content managing unit 204 newly generates the transmitted position information serving as reproducing mode information and a reproducing identifier (middle part reproducing URI) associated with the content identifier (step SF-5). The reproducing identifier (middle part reproducing URI) may be a character string such as /movie/history01.mpg. It is assumed that the reproducing identifier does not overlap another reproducing identifier on the server device 100.

The content managing unit 204 registers the “content identifier”, “interruption position information”, and the “reproducing identifier” in the content information DB 205 (see FIG. 5) (step SF-6).

The content managing unit 204 adds the middle part reproducing URI and attached information such as a user-friendly text that explains the URI to the CDS database to present the middle part reproducing URI to the client apparatus 300 (step SF-7).

FIG. 9 is a conceptual diagram for showing a display of a middle part reproducing list on the client apparatus 300 side. As the user-friendly descriptive text, for example, “middle part reproducing of xxx (program name)”, “watch the rest of xxx (program name)”, or the like are used.

When middle part reproducing is performed, the client apparatus 300 acquires the middle part reproducing URI from the CDS of the server device 100 and makes a content acquiring request to the server device 100 by using the URI. The server device 100 can acquire a content identifier to be transmitted to the client apparatus 300 and reproducing start position information serving as reproducing mode information from the received URI and can transmit the contents from a middle part to the client apparatus 300.

The middle part reproducing process is terminated.

[Digest Reproducing Process]

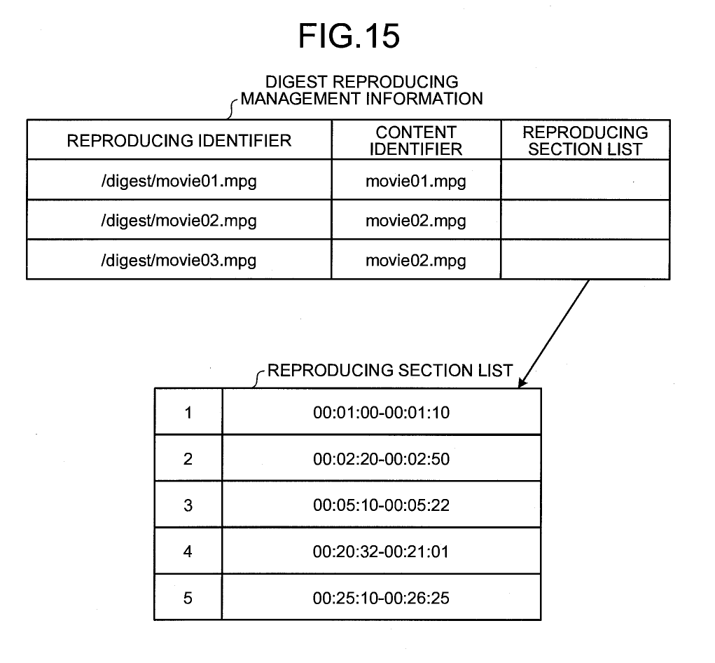

The following describes details of a digest reproducing process with reference to FIG. 15.

When a plurality of parts (scenes) are extracted from one content to be continuously reproduced (when some scenes are extracted and continuously reproduced), the method according to the embodiment can be used. In this case, a content identifier and a reproducing identifier (digest reproducing URI) associated with information (reproducing mode information) related to a content reproducing method are generated.

In an example explained below, one digest reproducing URI is set for one content reproducing method.

FIG. 15 is a diagram for showing outline of digest reproducing management information, and a reproducing section list that is reproducing mode information.

The server device 100 that has received a content acquiring request to the digest reproducing URI from the client apparatus 300 connects the content data and outputs the connected content data according to the content reproducing method with reference to a content identifier related to the digest reproducing URI and the reproducing mode information which defines the content reproducing method (see a reproducing section list in FIG. 15).

At this time, a connection portion is aligned to a position that is suitable for reproducing. For example, when the contents are encoded by the MPEG scheme, all of encoding data, a start position, and an end position corresponding to each scene are preferably positions of GOP boundaries.

When digest reproducing URIs, the number of which is equal to the number of reproducing sections (scenes) included in a content reproducing method defined by one piece of reproducing mode information are set, each of the digest reproducing URIs is associated with a start position, an end position, and a content identifier of each of the sections. The server device 100 presents these digest reproducing URIs to the client apparatus 300 as one set.

When the CDS is used, a digest reproducing URI group corresponding to one content reproducing method may be stored in one Container.

Each of the digest reproducing URIs may be described as Item in the Container.

The client apparatus 300 that has acquired the digest reproducing URI group sequentially issues content acquiring requests by the URIs to make it possible to acquire and reproduce a plurality of reproducing sections.

The digest reproducing process is terminated.

[Continuous Reproducing Process]

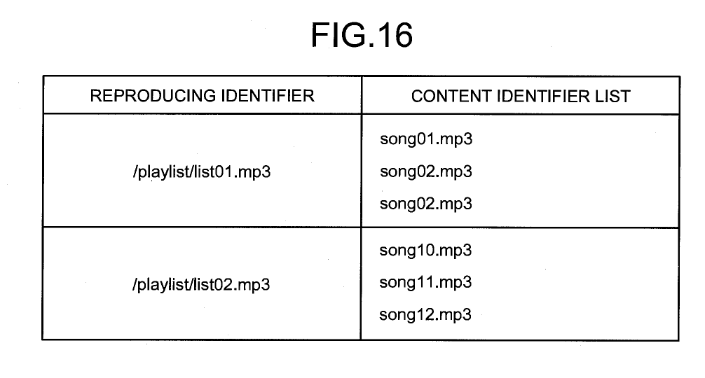

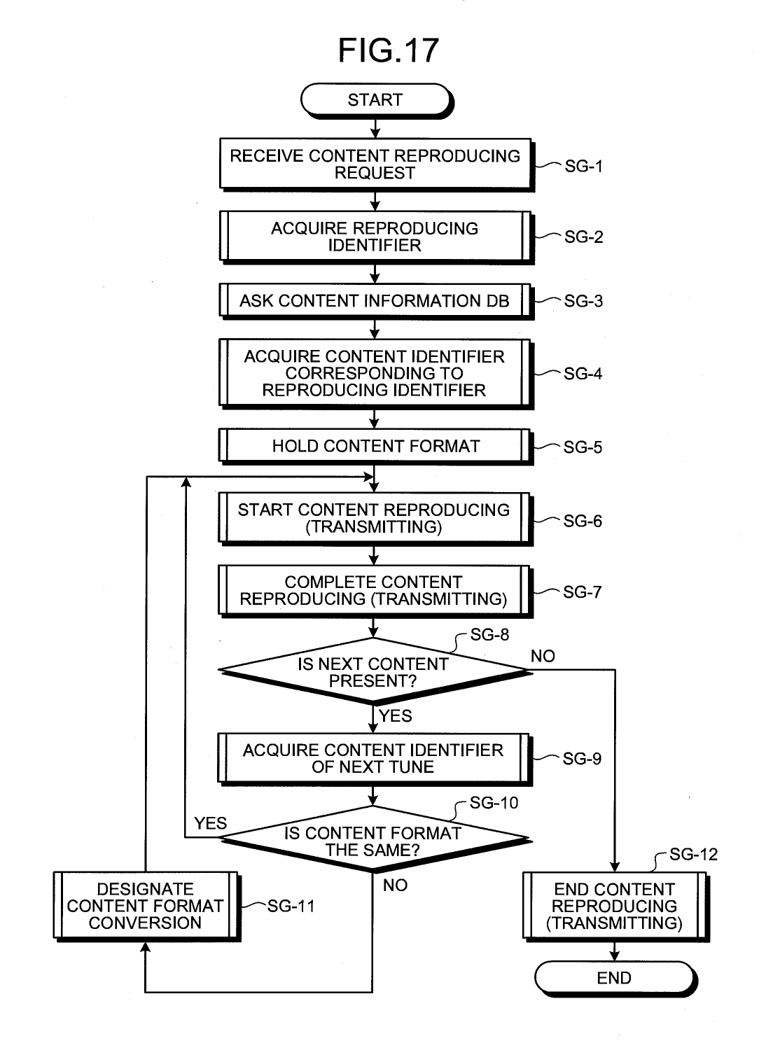

The following describes details of a continuous reproducing process with reference to FIGS. 16 and 17.

In the digest reproducing process, a reproducing method to one content is described. This can also be applied to continuous reproducing of a plurality of contents.

FIG. 16 is a view for showing outline of continuous reproducing management information, and FIG. 17 is a flow chart for showing an example of a continuous reproducing process executed by the server device 100.

As shown in FIG. 17, the server device 100 generates a plurality of content identifiers and a reproducing identifier (continuous reproducing URI) associated with information of a content reproducing order serving as reproducing mode information as continuous reproducing management information (see FIG. 16).

When the client apparatus 300 issues a request to designate the continuous reproducing URI, the server device 100 connects and outputs streams of the contents associated with the continuous reproducing URI according to a reproducing order similarly associated with the contents and a reproducing method (step SG-1 to step SG-12). An explanation of the process of each step will be omitted (see the explanation of the same steps of the flow chart (FIG. 12 or the like).

Therefore, for example, in music reproducing, the client apparatus 300 can continuously reproduce a plurality of music contents without holding a play list. In this case, encoding formats of consecutive contents must be the same with each other. When the encoding formats are different from each other, a tune to be reproduced next is converted into a tune in an encoding format of the previous tune to output the tune.

In this case, a URI and CDS information related to contents reproduced currently by the continuous reproducing URI are generated as needed and presented to the client apparatus 300 to make it possible to present information of the contents reproduced currently to the client apparatus 300 in continuous reproducing.

The continuous reproducing process is terminated.

[Chorus Continuous Reproducing Process]

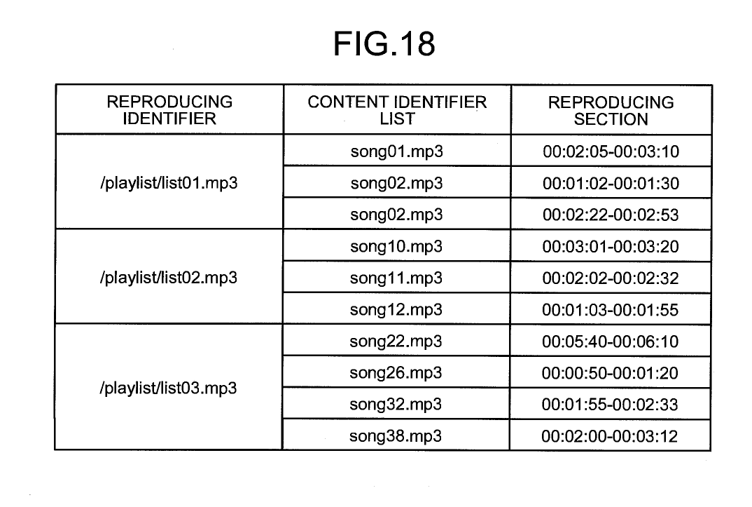

The following describes details of a chorus continuous reproducing process with reference to FIG. 18, and a FIG. 18 is a diagram for showing outline of chorus continuous reproducing management information.

A reproducing section designation is added to the above continuous reproducing method to make it possible to continuously perform partial reproducing of a plurality of tunes. As shown in FIG. 18, reproducing section information of each tune is added as reproducing mode information, and the server device 100 extracts a reproducing section designated from each content and transmits the reproducing sections to the client apparatus 300 while connecting the reproducing sections.

In this case, as in the continuous reproducing method described above, when the encoding format of a tune is different from that of a previous tune, the next tune may be converted into a tune of the same encoding format as that of the previous tune, and the converted tune may be output.

The chorus continuous reproducing process is terminated.

[Middle Part Reproducing Process in Continuous Reproducing]

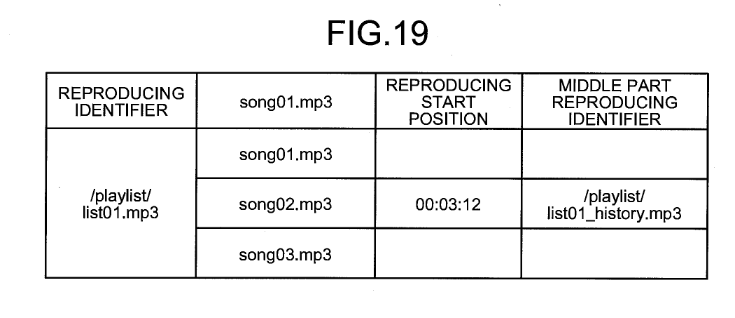

Details of a middle part reproducing process in continuous reproducing will be described below with reference to FIG. 19. FIG. 19 is a diagram for showing an outline of continuous reproducing management information.

In the continuous reproducing method, by using interruption of a communication path or detection of a stopping operation by the client apparatus 300 as a trigger, the server device 100 holds an identifier of contents which is being reproduced currently and a transmitted position of contents (reproducing start position; for example, reproducing elapsed time from the start of contents, and a sector on a hard disk) obtained when a stop is detected as reproducing mode information.

The server device 100 allocates a new reproducing identifier (middle part reproducing identifier) to the held information and stores the information in the storage device 104 as continuous reproducing management information (see FIG. 19), temporarily stops the continuous reproducing, and restarts the contents from a middle part.

The server device 100 that has started a reproducing operation by the middle part reproducing identifier can continuously execute the continuous reproducing operation.

The middle part reproducing process in continuous reproducing is terminated.

[Repeat Reproducing Process]

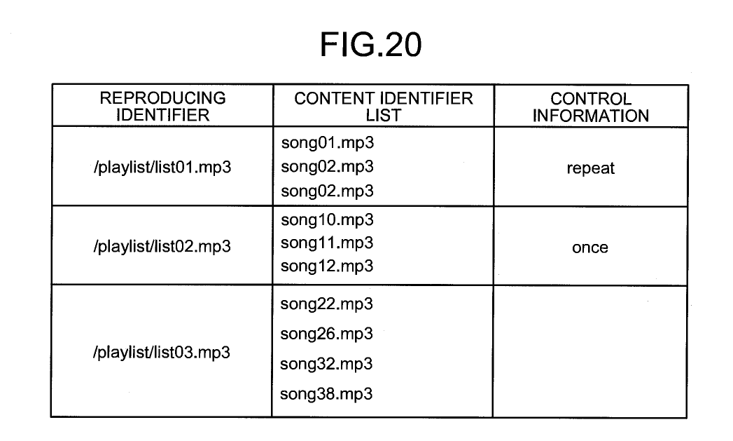

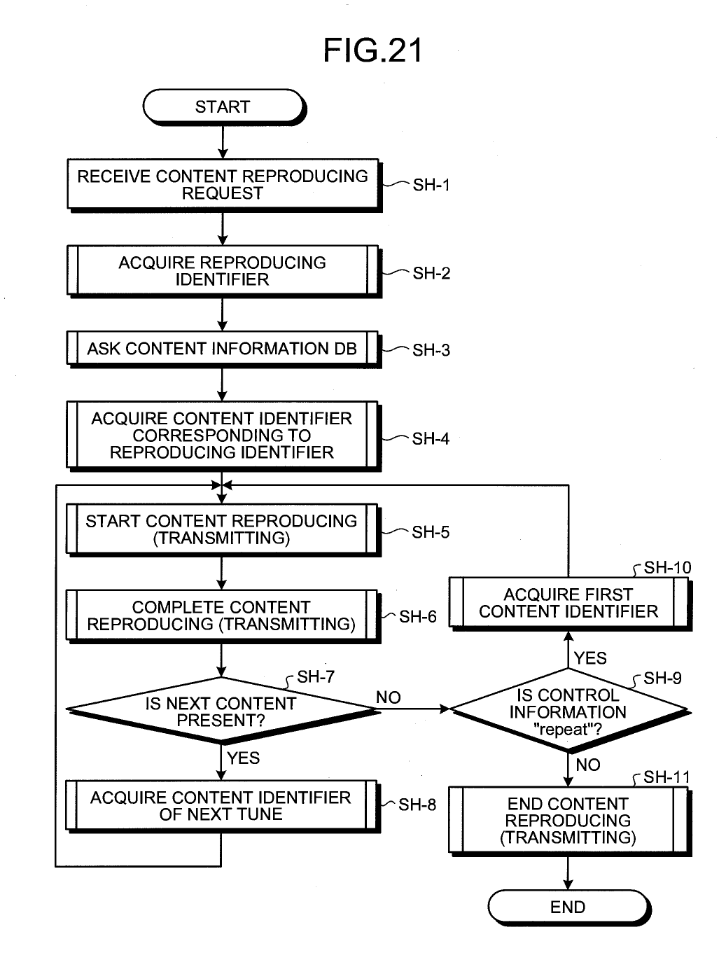

The following describes details of a repeat reproducing process with reference to FIGS. 20 and 21. FIG. 20 is a diagram for showing an outline of repeat reproducing management information, and FIG. 21 is a flow chart for showing an example of a repeat reproducing process executed in the server device 100.

The server device 100 generates the content management information as shown in FIG. 20 in advance. More specifically, the server device 100 allocates a new reproducing identifier to a content identifier and a combination between pieces of control information (the number of times of reproducing, repeat, or the like) as reproducing management information and manages the content identifier and the control information. The client apparatus 300 acquires a URI character string such as http://192.168.1.1:8080/playlist/list01.mp3 in advance by the CDS. The client apparatus 300 makes a content reproducing request by using the URI (step SH-1).

When the server device 100 accepts a request to the URI from the client apparatus 300 (step SH-1), the content managing unit 204 acquires a reproducing identifier such as /playlist/list01.mp3 from the URI (step SH-2).

The content managing unit 204 asks the content information DB 205 (step SH-3).

The content managing unit 204 acquires the content identifier from the corresponding reproducing identifier (step SH-4), and the content delivering process unit 203 starts transmitting of the contents through the content storage unit 201 and the communication processing unit 202 (step SH-5).

As the content management information, control information (“repeat” in step SH-9 in FIG. 21 or the like) representing repeat reproducing may be included. When the server device 100 finishes the transmitting of the contents throughout, the server device 100 can perform repeat reproducing by transmitting the contents again according to the control information (step SH-5 to step SH-10).

When the same control information is added to continuous reproducing, the continuous reproducing can be repeated.

The repeat reproducing process is terminated.

[Middle Part Reproducing Process of a Plurality of Rate Contents]

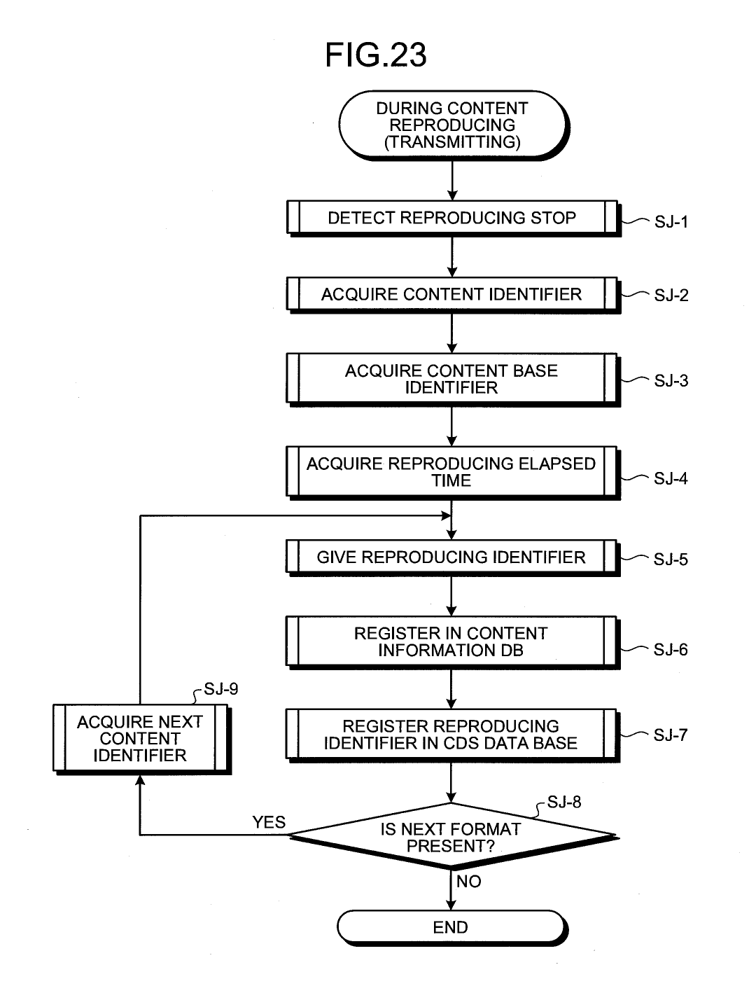

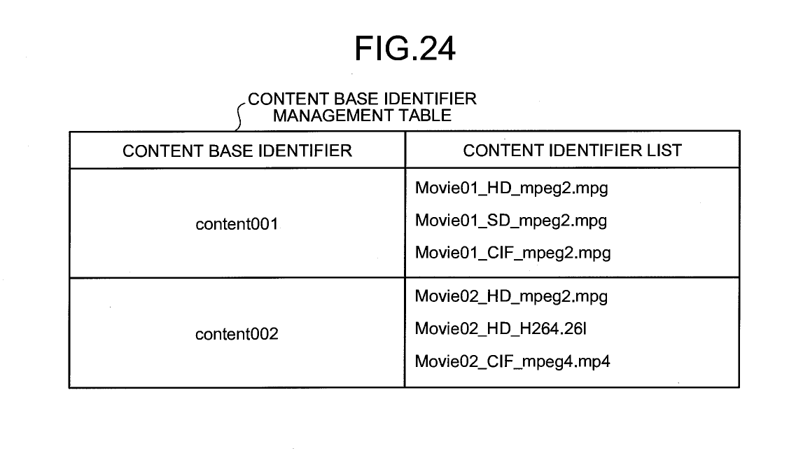

The following describes details of a middle part reproducing process of a plurality of rate contents with reference to FIGS. 23 and 24.

Even in contents having the same details, a plurality of content data which are different in quality may be held in the server device 100. More specifically, the data includes high-bit-rate content data for a high definition monitor, low-bit-rate content data for mobile equipment, and the like.

The server device 100 manages the contents having the same details as content database identifier management information as shown in FIG. 24.

FIG. 24 is a diagram for showing an outline of content base identifier management information.

More specifically, in FIG. 24, although the content base identifier has a different data format (for example, an encoding rate, and a format), the content base identifier is used to specify the same program.

For example, FIG. 24 shows that a “program” specified by content002 can be acquired as three pieces of content data encoded by formats, i.e., MPEG2, H.264, and MPEG4. Even when the content data does not have a substance, content data which can be generated by a trans-code or the like suffices.

FIG. 23 is a flow chart for showing an example of the middle part reproducing process of a plurality of rate contents executed by the server device 100.

FIG. 23 is for explaining an example of a method of performing middle part reproducing when different formats are used in the same program. This embodiment can be applied to a case in which, for example, a low-image-quality edition is viewed and interrupted in a mobile environment, and later a high-image-quality edition is reproduced from a middle part through a high-definition monitor. For this reason, the server device 100 generates middle part reproducing URIs to all the contents data (specified by content identifiers) in the same program.

First, the client apparatus 300 views low-bit-rate contents and stops at a middle part. More specifically, the server device 100 starts the process by using interruption of TCP communication from the client apparatus 300 or reception of a stopping operation from the client apparatus 300 as a trigger (step SJ-1).

When the server device 100 detects a reproducing stop, the content managing unit 204 generates middle part reproducing management information as in the middle part reproducing method (step SJ-2 to step SJ-9). In this case, the content managing unit 204 also generates middle part reproducing management information to high-bit-rate contents corresponding to the low-bit-rate contents with reference to content base identifier management information shown in FIG. 24 (step SJ-8 or the like). Since contents having different bit rates include different content data, reproducing elapsed time from the start of the contents but not a position on the hard disk is stored (step SJ-4).

When the client apparatus 300 designates a middle part reproducing URI corresponding to a high bit rate to request to reproduce contents, the server device 100 acquires a high-bit-rate content identifier and information of time position to be restarted from a reproducing identifier corresponding to the middle part reproducing URI, and transmits high-bit-rate contents from a middle part. In this manner, low-bit-rate contents are viewed partway, and the rest of the content can be viewed at a high bit rate.

The middle part reproducing process of a plurality of rate contents is terminated.

[Content List Presenting Process]

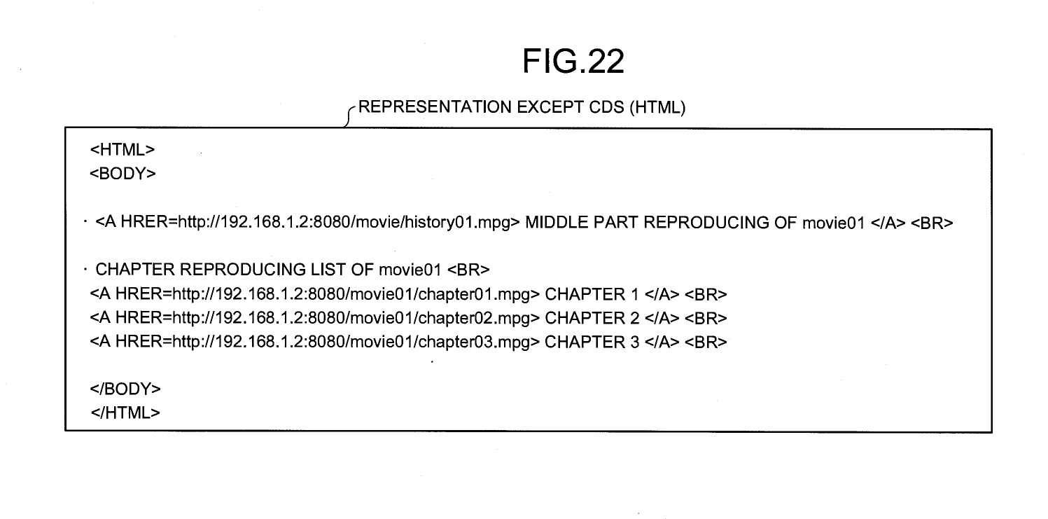

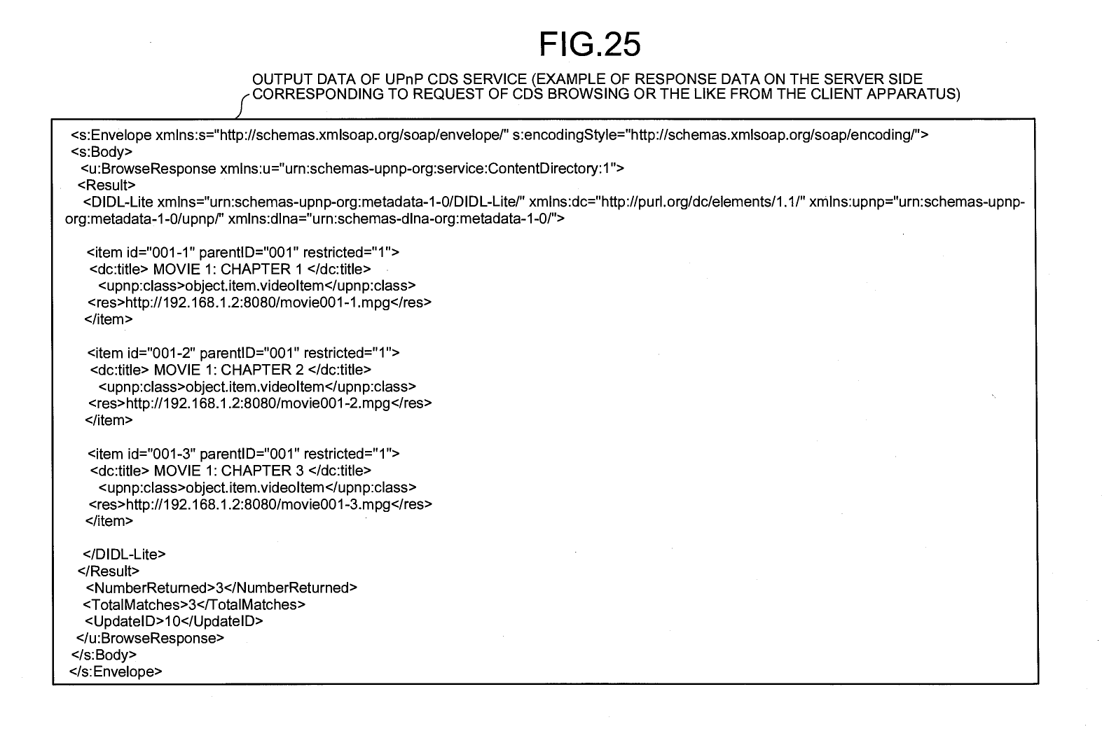

The following describes details of a content list presenting process with reference to FIGS. 22 and 25.

In content list presentation in the embodiment described above, an example of output data obtained when a UPnP CDS is used is shown in FIG. 25. FIG. 25 is a diagram for showing an example of response data on the server side corresponding to a request of CDS browsing or the like from the client apparatus 300 that uses the UPnP CDS. In a format such as a UPnP CDS format in which attached information can be added, a user-friendly descriptive text for explaining a URI can be added.

Output data of the content list may have any format in which a URI character string can be described.

FIG. 22 is a diagram for showing an example of response data on the server side corresponding to a request from the client apparatus 300 using HTML.

The content list presenting process is terminated.

### Other Embodiments

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

For example, in the embodiment, the method of reproducing moving image contents is mainly described. However, the present invention can be similarly applied to stream data such as music contents.

All the automatic processes explained in the present embodiment can be, entirely or partially, carried out manually. Similarly, all the manual processes explained in the present embodiment can be, entirely or partially, carried out automatically by a known method.

The process procedures, the control procedures, specific names, information including registration data for each process and various parameters such as search conditions, display example, and database construction, mentioned in the description and drawings can be changed as required unless otherwise specified.

The constituent elements of the server device 100 and the client apparatus 300 are merely conceptual and may not necessarily physically resemble the structures shown in the drawings. For instance, the apparatus need not necessarily have the structure that is illustrated. For example, the process functions performed by each device of the server device 100 and the client apparatus 300, especially the each process function performed by the control unit, can be entirely or partially realized by CPU and a computer program executed by the CPU or by a hardware using wired logic. The computer program, recorded on a recording medium to be described later, can be mechanically read by the server device 100 as the situation demands.

As the server device 100 and the client apparatus 300, known network-compatible audiovisual equipment may be used. The server device 100 and the client apparatus 300 may be realized such that peripheral devices such as a printer, a monitor, and an image scanner are connected to an information processing device such as an information processing terminal, e.g., a personal computer or a workstation, and software (including program, data, or the like) that realizes the method of the embodiment in the information processing device.

The distribution and integration of the server device 100 and the client apparatus 300 are not limited to those illustrated in the figures. The device as a whole or in parts can be functionally or physically distributed or integrated in an arbitrary unit according to various attachments or how the device is to be used. For example, each database may form a stand-alone database device, and a part of process may be executed by using common gateway interface (CGI).

Each process as a whole or in parts implemented by the server device 100 and the client apparatus 300 may be executed by CPU and a computer program read by CPU. In other words, the storage unit such as ROM or hard disk (HD) stores the computer program that can work in coordination with the operating system (OS) to issue commands to the CPU and cause the CPU to perform various processes. The computer program is first loaded to the RAM, and forms a control unit in collaboration with the CPU.

The computer-readable recording medium on which the computer program can be stored may be a portable type such as flexible disk, magneto optic (MO) disk, ROM, erasable programmable ROM (EPROM), electrically erasable programmable ROM (EEPROM), compact disk-read-only memory (CD-ROM), digital versatile disk (DVD), or a communication medium that stores the computer program for a short term such as communication channels or carrier waves that transmit the computer program over networks such as local area network (LAN), wide area network (WAN), and the Internet.

Computer program refers to a data processing method written in any computer language and written method, and can have software codes and binary codes in any format. The computer program can be a dispersed form in the form of a plurality of modules or libraries, or can perform various functions in collaboration with a different program such as the OS. Any known configuration in the each device according to the embodiment can be used for reading the recording medium. Similarly, any known process procedure for reading or installing the computer program can be used.

### INDUSTRIAL APPLICABILITY

As described above, the present invention can provide a content delivery system, a server device, a content delivery method, and a program in which information related to chapter reproducing is held in only a server device, and partial reproducing of contents can be easily performed without using sharing of reproducing start position information by a client apparatus and the server device, control using a reproducing start position or the like as an argument, or the like.

1. A content delivery system that is configured to communicably connect a server device that holds content data and a client apparatus that requests to reproduce the content data, wherein
the server device includes a storage device and a control device,
the storage device includes:
a content storage unit that stores a content identifier which uniquely identifies the content data and the content data in association with each other; and
a content information storage unit that stores a reproducing identifier in association with the content identifier and reproducing mode information which defines information on at least a reproducing position as a reproducing mode of the content data specified by the content identifier, and
the control device includes:
a list transmitting unit that transmits a list of the reproducing identifier to the client apparatus;
a request receiving unit that receives the reproducing identifier included in the list from the client apparatus; and
a content transmitting unit that acquires the content identifier and the reproducing mode information stored in the content information storage unit corresponding to the reproducing identifier received by the request receiving unit, acquires the content data stored in the content storage unit corresponding to the content identifier, and transmits the content data to the client apparatus in the reproducing mode designated by the reproducing mode information.

2. The content delivery system according to claim 1, wherein
the reproducing mode information includes at least one of reproducing start position information, reproducing range information, and reproducing control information.

3. The content delivery system according to claim 2, wherein
the reproducing control information includes at least one of pieces of control information related to the number of times of reproducing, repeat, an encoding rate, and a format.

4. The content delivery system according to claim 1, wherein
the plurality of pieces of reproducing mode information correspond to the one reproducing identifier.

5. The content delivery system according to claim 1, wherein
the plurality of content identifiers and the plurality of pieces of reproducing mode information correspond to the one reproducing identifier.

6. The content delivery system according to claim 1, wherein
the request receiving unit receives the reproducing identifier selected by a user in the reproducing identifiers included in the list from the client apparatus.

7. The content delivery system according to claim 1, wherein
the reproducing identifier is a URI.

8. The content delivery system according to claim 1, wherein
the list transmitting unit transmits the list in a format conforming to UPnP CDS.

9. A server device in a content delivery system that is configured to communicably connect the server device that holds content data and a client apparatus that requests to reproduce the content data, comprising:
a storage device; and
a control device, wherein
the storage device includes:
a content storage unit that stores a content identifier which uniquely identifies the content data and the content data in association with each other; and
a content information storage unit that stores a reproducing identifier in association with the content identifier and reproducing mode information which defines information on at least a reproducing position as a reproducing mode of the content data specified by the content identifier, and
the control device includes:
a list transmitting unit that transmits a list of the reproducing identifier to the client apparatus;
a request receiving unit that receives the reproducing identifier included in the list from the client apparatus; and
a content transmitting unit that acquires the content identifier and the reproducing mode information stored in the content information storage unit corresponding to the reproducing identifier received by the request receiving unit, acquires the content data stored in the content storage unit corresponding to the content identifier, and transmits the content data to the client apparatus in the reproducing mode designated by the reproducing mode information.

10. A content delivery method executed by a content delivery system that is configured to communicably connect a server device that holds content data and a client apparatus that requests to reproduce the content data, wherein
the server device includes a storage device and a control device,
the storage device includes:
a content storage unit that stores a content identifier which uniquely identifies the content data and the content data in association with each other; and
a content information storage unit that stores a reproducing identifier in association with the content identifier and reproducing mode information which defines information on at least a reproducing position as a reproducing mode of the content data specified by the content identifier,
the method comprising:
a list transmitting step of transmitting a list of the reproducing identifier to the client apparatus;
a request receiving step of receiving the reproducing identifier included in the list from the client apparatus; and
a content transmitting step of acquiring the content identifier and the reproducing mode information stored in the content information storage unit corresponding to the reproducing identifier received by the request receiving unit, acquires the content data stored in the content storage unit corresponding to the content identifier, and transmits the content data to the client apparatus in the reproducing mode designated by the reproducing mode information.

11. A computer program product having a computer readable medium including programmed instructions for executing an content delivery method by a server device in a content delivery system that is configured to communicably connect the server device that holds content data and a client apparatus that requests to reproduce the content data, including:
a storage device; and
a control device, wherein
the storage device includes:
a content storage unit that stores a content identifier which uniquely identifies the content data and the content data in association with each other; and
a content information storage unit that stores a reproducing identifier in association with the content identifier and reproducing mode information which defines information on at least a reproducing position as a reproducing mode of the content data specified by the content identifier, and
the instructions, when executed by a computer, cause the computer to perform
a list transmitting step of transmitting a list of the reproducing identifier to the client apparatus;
a request receiving step of receiving the reproducing identifier included in the list from the client apparatus; and
a content transmitting step of acquiring the content identifier and the reproducing mode information stored in the content information storage unit corresponding to the reproducing identifier received by the request receiving unit, acquires the content data stored in the content storage unit corresponding to the content identifier, and transmits the content data to the client apparatus in the reproducing mode designated by the reproducing mode information.
